(19) United States
(12) Patent Application Publication
(10) Pub. No.: US 2009/0154196 A1
(43) Pub. Date: Jun. 18, 2009

(54) FLEXIBLE LIGHT EMITTING DEVICE

(75) Inventors: Hui-Hsiung Lin, Hsinchu County (TW); Yu-Nan Pao, Hsinchu County (TW); Wen-Hsun Yang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/127,019

(22) Filed: May 27, 2008

(30) Foreign Application Priority Data
Dec. 13, 2007 (TW) 96147657

(51) Int. Cl. F21V 23/00; F21V 7/00

(52) U.S. Cl. 362/613

(57) ABSTRACT

A flexible light emitting device including at least one light source and a flexible light guide is provided. The flexible light guide has at least one light emitting surface and at least one light incident surface. Moreover, micro-structures are located on at least one surface of the flexible light guide except the light incident surface. The light source is disposed beside the light incident surface of the flexible light guide. When the light of the light source is incident into the flexible light guide, the total reflection would be destroyed due to the micro-structures, and thus the light could emit out of the flexible light guide from the light emitting surface.

### CROSS-REFERENCE TO RELATED APPLICATION

This application claims the priority benefit of Taiwan application serial no. 96147657, filed on Dec. 13, 2007. The entirety of the above-mentioned patent application is hereby incorporated by reference herein and made a part of this specification.

### BACKGROUND OF THE INVENTION

1. Field of the Invention

The present invention generally relates to a flexible light emitting device, in particular, to a light emitting device capable of converting a point light source into a luminous body of any shape.

2. Description of Related Art

In recent years, as the luminous efficiency of light-emitting diodes (LEDs) is continuously increased, the LEDs have gradually replaced fluorescent lamps and incandescent lamps in many fields, for example, lamps for scanners requiring a high-speed response, backlights for liquid crystal displays (LCDs), or dashboard illuminators for automobiles with front light sources, traffic lights, common lighting equipments, and light sources for projectors. As the luminescence of LED is not generated due to heating or discharging, but belongs to cold luminescence, the service life of the LED reaches over 100,000 hours. Furthermore, the LED further has the advantages of high response speed (about 10⁻⁹ seconds), small volume, low power consumption, low pollution, high reliability, and suitable for mass production; and thus the LED has been widely applied in extensive application fields. However, as the LED is a point light source and has a strong directivity, its applications are somewhat restricted.

U.S. Pat. No. 6,280,044 discloses an illuminating apparatus, which is applicable for backlight modules and includes a light guiding bar, an LED light source, and a light guiding plate. The light guiding bar is formed with a plurality of V-shaped grooves on a surface thereof. After the light of the LED light source is incident on the light guiding bar, the light emits out of the light guiding bar uniformly, such that the point light source is converted into a linear light source, and then the linear light source is converted into a surface light source through a light guiding plate. However, the illuminating apparatus disclosed in the patent is applied to backlight modules, and the bar-like light guiding bar has a rigid rectangular cylindrical structure.

### SUMMARY OF THE INVENTION

Accordingly, the present invention is directed to a flexible light emitting device, which is capable of converting a point light source into a luminous body of any shape.

The present invention provides a flexible light emitting device, which includes at least one light source and a flexible light guide. The flexible light guide, with a flexible radius of curvature of less than 30 cm, includes at least one light emitting surface and at least one light incident surface. The flexible light guide is formed with a plurality of micro-structures on at least one surface thereof except the light incident surface. The light source is disposed beside the light incident surface of the flexible light guide. When the light of the light source is incident into the flexible light guide, the total reflection thereof is destroyed due to the micro-structures, and thus the light emits out of the flexible light guide from the light emitting surface.

The flexible light emitting device of the present invention combines the light source with the flexible light guide having micro-structures, so as to convert a point light source into a luminous body of any shape. Therefore, the flexible light emitting device and lighting equipments using the same are capable of being configured into any shape according to the users' requirements or the space design.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a flexible light emitting device according to an embodiment of the present invention.

FIG. 2 is a schematic view of a flexible light emitting device according to another embodiment of the present invention.

FIGS. 3A to 3E are schematic views of a flexible light guide.

FIGS. 4 to 9 are schematic views of a flexible light emitting device according to embodiments of the present invention.

FIG. 10 is a schematic view of a lighting equipment according to an embodiment of the present invention.

FIG. 11 is a relationship diagram between viewing angle and luminous intensity at different depths (heights) of micro-structures of the flexible light emitting device.

FIG. 12 is a relationship diagram between viewing angle and luminous intensity at different pitches between the micro-structures of the flexible light emitting device.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

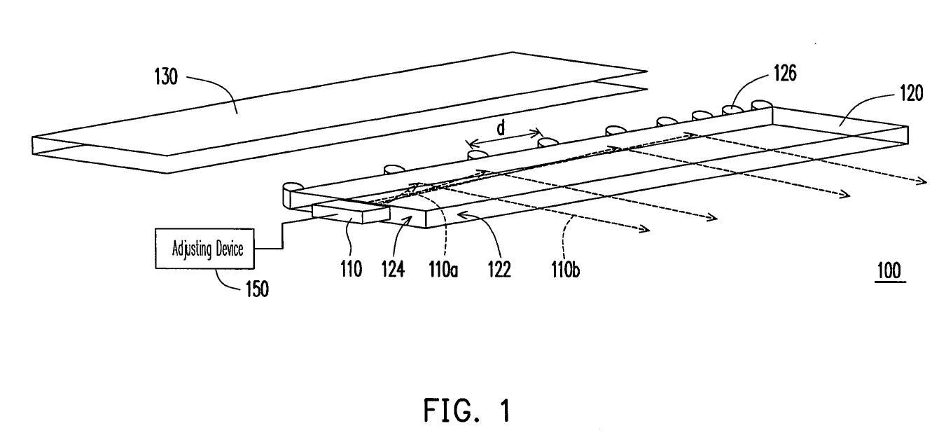

FIG. 1 is a schematic view of a flexible light emitting device according to an embodiment of the present invention. Referring to FIG. 1, a flexible light emitting device 100 includes at least one light source 110 and a flexible light guide 120. The flexible light guide 120 has at least one light emitting surface 122 and at least one light incident surface 124, and has a plurality of micro-structures 126 located on at least one surface thereof except the light incident surface 124. The light source 110 is disposed beside the light incident surface 124 of the flexible light guide 120. When the light of the light source 110 is incident into the flexible light guide 120, the total reflection thereof may be destroyed due to the micro-structures 126, and thus the light emits out of the flexible light guide 120 from the light emitting surface 122. Particularly, as the flexible light guide 120 has a plurality of micro-structures 126 located on at least one surface thereof except the light incident surface 124, when the lights 110a of the light source 110 are incident on any surface of the flexible light guide 120, most of the lights are transferred within the flexible light guide 120 in the manner of total reflection, till the light meets the surface of the micro-structures 126, and at this time, the total reflection is destroyed by the surface having the micro-structures 126 thereon, and thus the lights 110b emit out of the flexible light guide 120 from the light emitting surface 122. In other words, due to the existence of the micro-structures 126, it does not merely emitting lights at the front and rear ends of the flexible light guide 120, instead the lights emit out of the flexible light guide 120 from a corresponding surface having the micro-structures 126 disposed thereon.

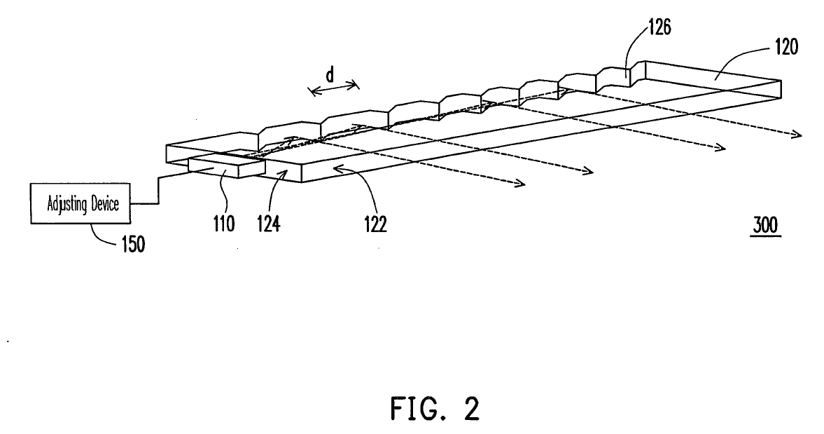

In this embodiment, the micro-structures 126 are structures protruded from the flexible light guide 120, for example, semi-cylinders, semi-elliptic cylinders, polygonal cylinders, spheroids or pyramids. However, the present invention is not limited to this, in an alternative embodiment, the micro-structures may also be structures depressed into the flexible light guide, as shown in FIG. 2. The micro-structures 126 shown in FIG. 2 are groove-shaped micro-structures, for example, semi-cylindrical grooves, semi-elliptic cylindrical grooves, spheroid-shaped grooves, or polygonal cylindrical grooves. In an embodiment, the cross-section area between each micro-structure 126 and the flexible light guide 120 is less than 4 mm², and preferably falls in a range of 4 mm²-500 nm². Furthermore, a height of the micro-structures 126 less than a square root of the area of the cross-section. It should be noted that, the divergence angle of the light may also be controlled by adjusting the height of the micro-structures 126.

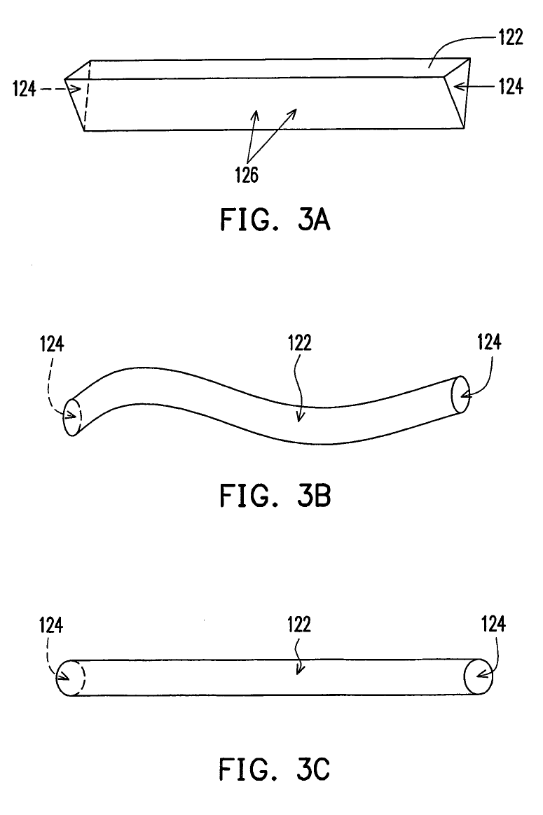

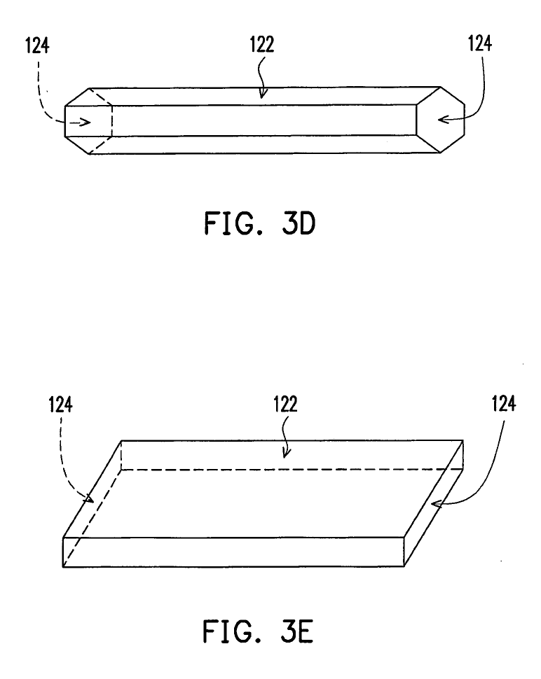

In addition, the flexible light guide 120 may have a polygonal, round, oval, or irregular-shaped cross-section. For example, as shown in FIG. 1, the flexible light guide 120 has a profile of square prism. Definitely, the flexible light guide 120 may also have a profile of triangular prism, distorted cylinder, or cylinder as shown in FIGS. 3A to 3C, or polygonal-shaped prism or flat plate as shown in FIGS. 3D and 3E. Particularly, the flexible light guide 120 may be a recoverable flexible light guide or unrecoverable flexible light guide. If the flexible light guide 120 is unrecoverable, once being distorted or deformed, it will be fixed at such a shape, unless another external force is further applied to make it deformed once again. If the flexible light guide 120 is recoverable, once being distorted or deformed, an additional fixing device is required to fix its shape, otherwise it will restore its original shape. Regardless of the recoverable or unrecoverable flexible light guide, it may be distorted or deformed randomly. In an embodiment, as for the flexible degree, the flexible light guide 120 has a flexible radius of curvature of less than 30 cm. Furthermore, the flexible light guide 120 is made of a transparent material, for example, UV curable resin or silica gel.

Furthermore, referring to FIGS. 1 and 2, in order to make the lights of the light source 110 uniformly emit out of the flexible light guide 120 from the light emitting surface 122 thereof, there is a pitch d between adjacent micro-structures 126, and the pitches d are decreased along the direction away from the light incident surface 124. In another embodiment, in order to make the lights of the light source 110 uniformly emit out of the flexible light guide 120 from the light emitting surface 122 thereof, the size of the micro-structures 126 is increased along the direction away from the light incident surface 124. In an embodiment, the pitch d between the micro-structures 126 is less than 5 mm, and preferably falls in a range of 5 mm-10 μm. It should be noted that, the intensity of the emitted lights may also be adjusted by adjusting the pitch between the micro-structures 126 (i.e., the density of the micro-structures).

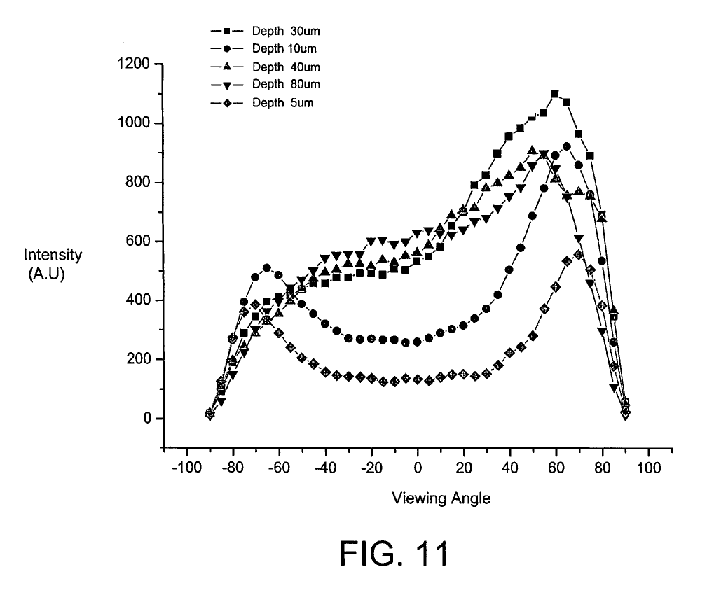

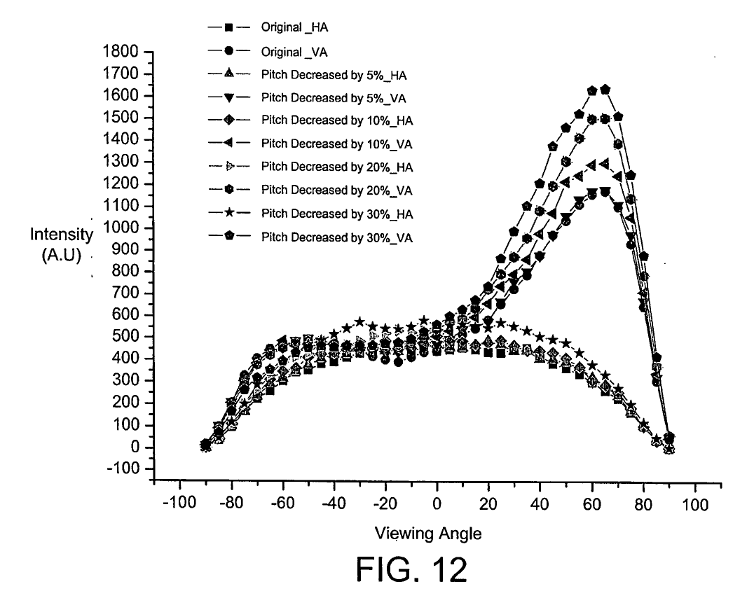

FIG. 11 is a relationship diagram between viewing angle and luminous intensity at different depths (heights) of micro-structures of the flexible light emitting device. FIG. 12 is a relationship diagram between viewing angle and luminous intensity at different pitches between the micro-structures of the flexible light emitting device. Firstly, referring to FIG. 11, a flexible light guide with a length of 126 mm, a width of 32 mm, and a height of 2.5 mm is tested, in which the micro-structures are hemisphere-shaped structures with a radius of 80 um. When the depth/height of the micro-structures is 5 um, 10 um, 30 um, 40 um, and 80 um, the relationship diagram between the viewing angle and the measured luminous intensity of the flexible light emitting device are shown. It can be known from FIG. 11 that, the luminous intensity of the light emitting device may be adjusted by adjusting the depth/height of the micro-structures. Therefore, the user can adjust the depth/heights of the micro-structures depending upon the actual requirements. Furthermore, referring to FIG. 12, similarly, a flexible light guide with a length of 126 mm, a width of 32 mm, and a height of 2.5 mm is tested, and the micro-structures are fixed to be hemisphere-shaped structures with a radius of 80 um and a depth of 20 um. When the pitches between the micro-structures are decreased by 5%, 10%, 20%, 30%, the relationship diagram between the viewing angle and the measured luminous intensity of the flexible light emitting device is shown. It can be known from FIG. 12 that, as the pitches are decreased (the density of the micro-structures is increased), the luminous intensity is increased. Therefore, the user can adjust the pitches of the micro-structures depending upon the actual requirements.

It should be noted that, the light source 110 may be a single LED (as shown in FIGS. 1 and 2) or an LED array, which is disposed beside the light incident surface 124 of the flexible light guide 120 through embedding or attaching process. Definitely, those of ordinary skill in the art can select an appropriate light source 110 depending upon the actual requirements. In an embodiment, the light source 110 is formed by LEDs of at least one color. That is to say, the light source 110 may be an LED of a single color or formed by LEDs of a plurality of colors. Furthermore, the flexible light emitting device further includes an adjusting device 150, electrically connected to the light source 110. The luminance variation and ON/OFF of the light source 110 may be set, that is, the variation of color lights emitted by the light source 110 may be set, through using the adjusting device 150.

Referring to FIG. 1, if it is expected to enhance the output at the light emitting surface of the flexible light emitting device, or it is expected that the flexible light emitting device has a specific surface for light emitting, the flexible light emitting device may further include a reflective layer. In the embodiment shown in FIG. 1, the flexible light emitting device 100 is in the form of emitting lights at a single surface, such that the reflective layer 130 covers the surfaces of the flexible light guide 120 except the light emitting surface 122 and the light incident surface 124. When an incident angle for a small portion of the lights to be incident on any surface of the flexible light guide 120 is smaller than an optical critical angle for the material interface, the lights may be reflected back to the flexible light guide 120 by the reflective layer 130 and then the lights are resumed to be transferred within the flexible light guide 120, and finally emit out of the flexible light guide 120 from the light emitting surface 122. That is, the reflective layer 130 may reflect the lights emitted from the surfaces covered thereby back to the flexible light guide 120, and thus preventing the lights from emitting out of the flexible light guide 120 from surfaces except the light emitting surface 122.

Definitely, the flexible light emitting device of the present invention is not limited to being in the form of emitting lights at a single surface, but may be in the form of emitting lights at multiple surfaces, and thus, the flexible light emitting device may be designed to have reflective layers 130 disposed on one surface, two surfaces, or three surfaces of the flexible light guide 120 or have no reflective layers 130 at all depending upon the actual design of the products. It should be noted that, the reflective layer 130 may be directly attached to the surfaces of the flexible light guide 120 except the light emitting surface 122 and the light incident surface 124, or may also be processed by a reflection coating process to be directly coated on the surfaces of the flexible light guide 120 except the light emitting surface 122 and the light incident surface 124.

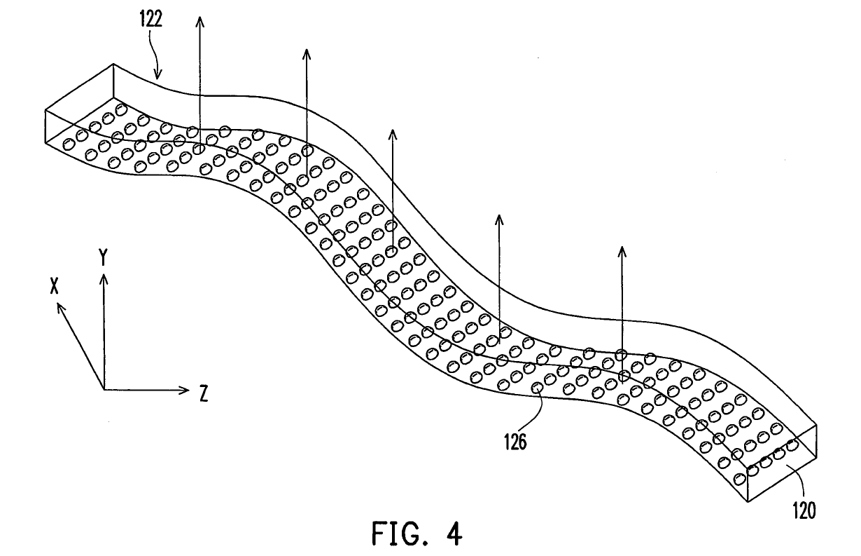

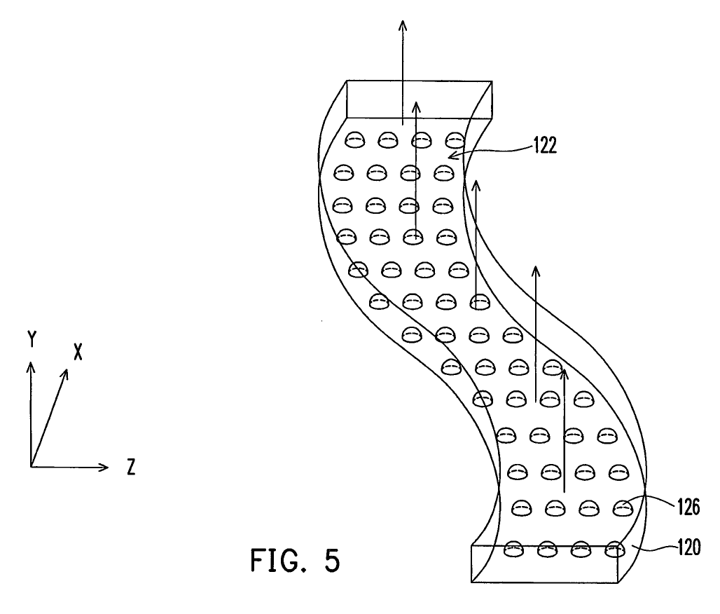

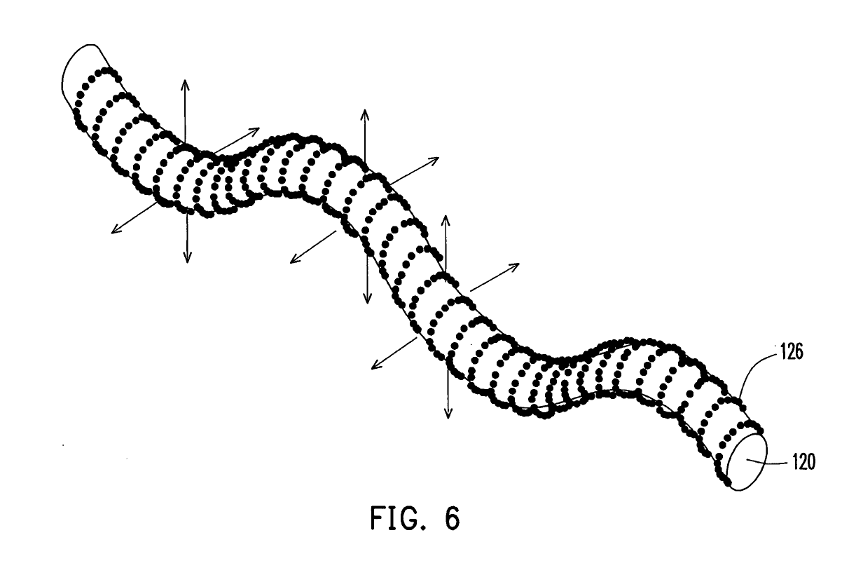

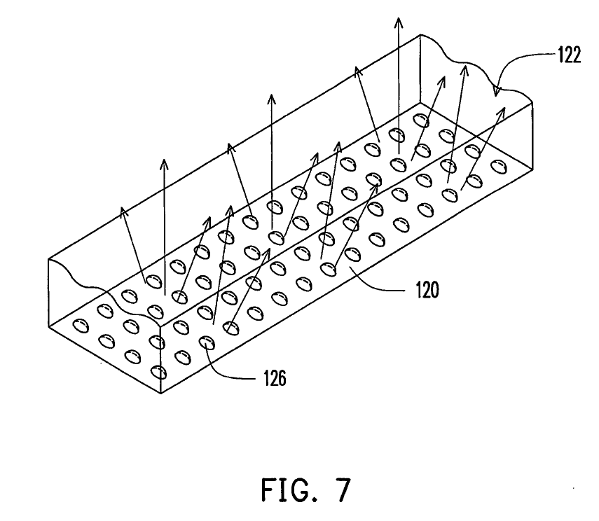

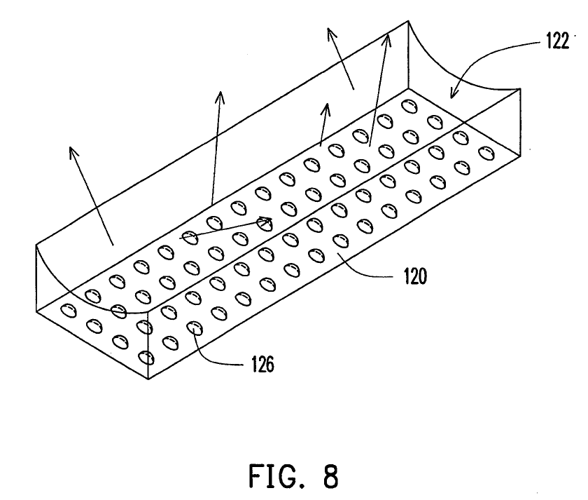

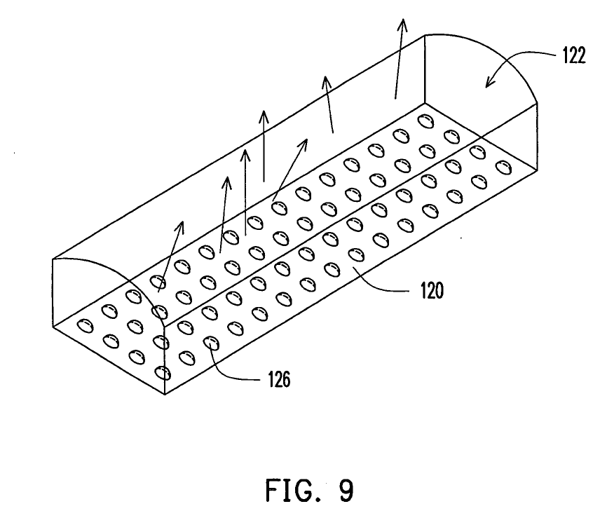

The light emitting surface 122 for the flexible light guide 120 in the above embodiments is a flat surface, but in the present invention, the light emitting surface 122 of the flexible light guide 120 may also be a curved surface or a waved surface, which is illustrated below in the following embodiments. As shown in FIG. 4, the flexible light guide 120 is in a curved bar shape and distorted towards the Y direction, and thus the light emitting surface 122 is a curved surface. In FIG. 5, the flexible light guide 120 is in another curved bar shape and distorted towards the Z direction, and thus the light emitting surface 122 is a flat surface. In FIG. 6, the flexible light guide 120 is in a distorted cylindrical bar shape, and the micro-structures 126 are disposed along the cylindrical surface. As the lights emit out from the area having the micro-structures 126 disposed thereon, the whole cylindrical surface will be luminescent. In FIG. 7, the light emitting surface 122 of the flexible light guide 120 is a waved surface. When the lights emit from the wave-shaped light emitting surface 122, a multi-layered luminous effect will be exhibited. In FIGS. 8 and 9, the light emitting surfaces as a concave surface or a convex surface are shown respectively.

In view of the above, the flexible light emitting device of the present invention can have any shape depending upon the users' requirements or space design. Furthermore, if the variation of the light emitting surface is utilized together, the emitting lights can exhibit various luminous effects. Therefore, the flexible light emitting device of the present invention can be widely applied in many application fields, such as portable light emitting devices, light emitting devices or lighting equipments with special configurations.

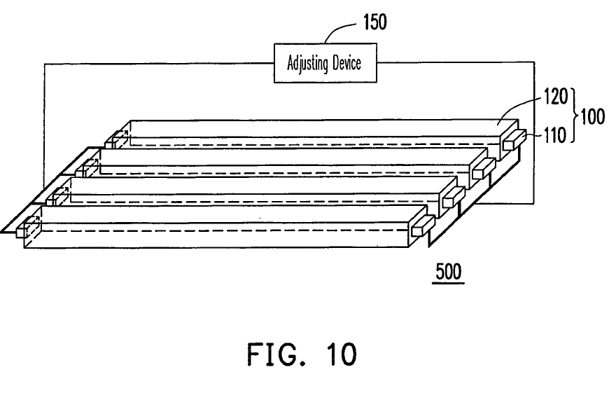

As shown in FIG. 10, the flexible light emitting device is applied in a lighting equipment. A lighting equipment 500 includes a plurality of flexible light emitting devices 100. Each flexible light emitting device includes at least one light source 110 and a flexible light guide 120. The light sources 110 of the plurality of flexible light emitting devices 100 are connected in series. Definitely, FIG. 10 is merely intended to illustrate the present invention, and those of ordinary skill in the art can appropriately adjust the arrangement of the flexible light emitting devices 100 or adopt the flexible light guide 120 in a suitable form or shape according to the actual requirements. For example, a plurality of flexible light emitting devices 100 may be arranged into an umbrella-shaped configuration, or a plurality of flexible light emitting devices 100 having distorted cylindrical-shaped flexible light guides are arranged together, so as to form a lamp with a special shape.

Furthermore, the lighting equipment further includes an adjusting device 150, electrically connected to the light source 110. Through the adjusting device 150, the luminance variation, and ON/OFF, and variation of color lights may be set for the lighting equipment. Therefore, such lighting equipment may be applied in home decorations, store or show-window decorations, and so on.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A flexible light emitting device, comprising:
a flexible light guide, with a flexible radius of curvature less than 30 cm, and comprising at least one light emitting surface and at least one light incident surface, wherein a plurality of micro-structures is located on at least one surface of the flexible light guide except the light incident surface; and
at least one light source, disposed beside the light incident surface of the flexible light guide, wherein when a light of the light source is incident into the flexible light guide, a total reflection thereof is destroyed due to the micro-structures, and thus the light emits out of the flexible light guide from the light emitting surface.

2. The flexible light emitting device according to claim 1, further comprising a reflective layer, located on a surface of the flexible light guide except the light emitting surface and the light incident surface.

3. The flexible light emitting device according to claim 1, wherein the light source is a single light-emitting diode (LED) or a light-emitting diode (LED) array.

4. The flexible light emitting device according to claim 1, wherein the flexible light guide is a recoverable flexible light guide or an unrecoverable flexible light guide.

5. The flexible light emitting device according to claim 1, wherein the flexible light guide has a polygonal, round, oval, or irregular-shaped cross section.

6. The flexible light emitting device according to claim 1, wherein the light emitting surface of the flexible light guide comprises a flat surface, a curved surface, or a waved surface.

7. The flexible light emitting device according to claim 1, wherein the material of the flexible light guide comprises an ultraviolet (UV) curable resin or silica gel.

8. The flexible light emitting device according to claim 1, wherein each of the micro-structures comprises semi-cylinder, semi-elliptic cylinder, polygonal cylinder, spheroid, or pyramid.

9. The flexible light emitting device according to claim 1, wherein each of the micro-structures comprises a semi-cylindrical groove, a semi-elliptic cylindrical groove, a spheroid-shaped groove, or a polygonal cylindrical groove.

10. The flexible light emitting device according to claim 1, wherein a pitch exists between each two adjacent micro-structures, and the pitches are decreased along a direction away from the light incident surface.

11. The flexible light emitting device according to claim 1, wherein the size of the micro-structures is increased along a direction away from the light incident surface.

12. The flexible light emitting device according to claim 1, wherein a cross-section area between each micro-stricture and the flexible light guide is less than 4 mm².

13. The flexible light emitting device according to claim 1, wherein a cross-section are between each of the micro-structures and the flexible light guide falls in a range of 4 mm²-500 nm².

14. The flexible light emitting device according to claim 1, wherein the pitch d between two adjacent micro-structures is less than 5 mm.

15. The flexible light emitting device according to claim 1, wherein the pitch d between two adjacent micro-structures falls in a range of 5 mm-10 μm.

16. The flexible light emitting device according to claim 12, wherein a height of each micro-structure is less than a square root of the area of the cross-section area.

17. The flexible light emitting device according to claim 1, wherein the light source is formed by light-emitting diodes (LEDs) of at least one color.

18. The flexible light emitting device according to claim 1, further comprising an adjusting device, electrically connected to the light source.
